(19) United States
(12) Patent Application Publication
(10) Pub. No.: US 2006/0191352 A1
(43) Pub. Date: Aug. 31, 2006

(54) Educational device to measure the strength and deflection of a truss

(76) Inventor: Richard R. Lewellen, Wooster, OH (US)

Correspondence Address: Kathleen K. Bowen Co., LPA, 311 Hillbrook Dr, Cuyahoga Falls, OH, 44223, US

(21) Appl. No.: 11/066,862

(22) Filed: Feb. 25, 2005

(51) Int. Cl. G01N 3/02

(52) U.S. Cl. 73/856

(57) ABSTRACT

An educational device to measure the strength and deflection of a sample truss comprises a mounting base having opposing posts, an adjustable sliding force plate, a load clip, a pulling means, a force measuring means, and a deflection measuring means. The truss has a longitudinal side and an opposing side with a load point, and a first end and an opposing second end. The truss is laid on the sliding force plate such that the longitudinal side is against the opposing posts, wherein one post is at the first end and one post is at the second end. The load clip is mounted on the sliding force plate, and centered relative to the opposing posts, such that when the truss is placed on the sliding force plate, the load clip is against the truss load point. The pulling means functions to pull the load clip against the truss load point, which in turn pulls the truss first longitudinal side against the opposing posts, causing a load on the truss. A force measuring means is then used for measuring the load caused by the pulling means, and a deflection measuring means is used for measuring the deflection of the truss caused by the pulling means.

### BACKGROUND

The present invention is in the field of science lab equipment. More specifically this invention relates to measuring the strength and deflection of a sample truss, to aid in learning about truss structures and strengths.

When teaching about trusses, such as various truss structures and how they differ in load bearing ability, it is useful to have a hands on experiment which could show this. Testing could be used to replicate a bridge structure, or to explore vector addition. Thus an apparatus is desired which would demonstrate this in a classroom setting.

### SUMMARY OF THE INVENTION

An educational device to measure the strength and deflection of a sample truss comprises a mounting base having opposing posts, an adjustable sliding force plate, a load clip, a pulling means, a force measuring means, and a deflection measuring means. The truss has a longitudinal side and an opposing side with a load point, and a first end and an opposing second end. The truss is laid on the sliding force plate such that the longitudinal side is against the opposing posts, wherein one post is at the first end and one post is at the second end. The load clip is mounted on the sliding force plate, and centered relative to the opposing posts, such that when the truss is placed on the sliding force plate, the load clip is against the truss load point. The pulling means functions to pull the load clip against the truss load point, which in turn pulls the truss first longitudinal side against the opposing posts, causing a load on the truss. A force measuring means is then used for measuring the load caused by the pulling means, and a deflection measuring means is used for measuring the deflection of the truss caused by the pulling means.

### BRIEF DESCRIPTION OF THE DRAWINGS

FIG. 1 is an isometric view of an educational device to measure the strength and deflection of a truss, according to an aspect of the invention.

FIG. 2 is an exploded view of a portion of an educational device to measure the strength and deflection of a truss, according to an aspect of the invention.

### DETAILED DESCRIPTION

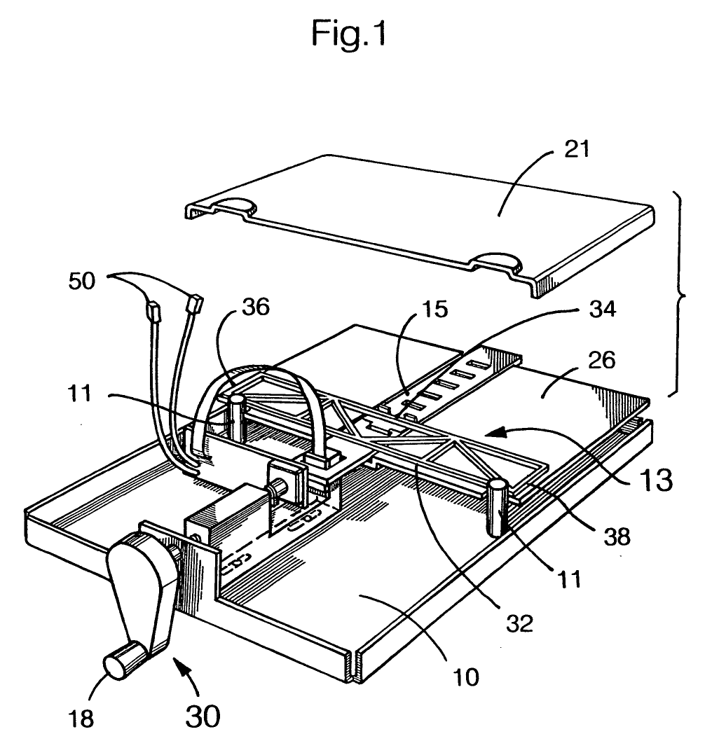

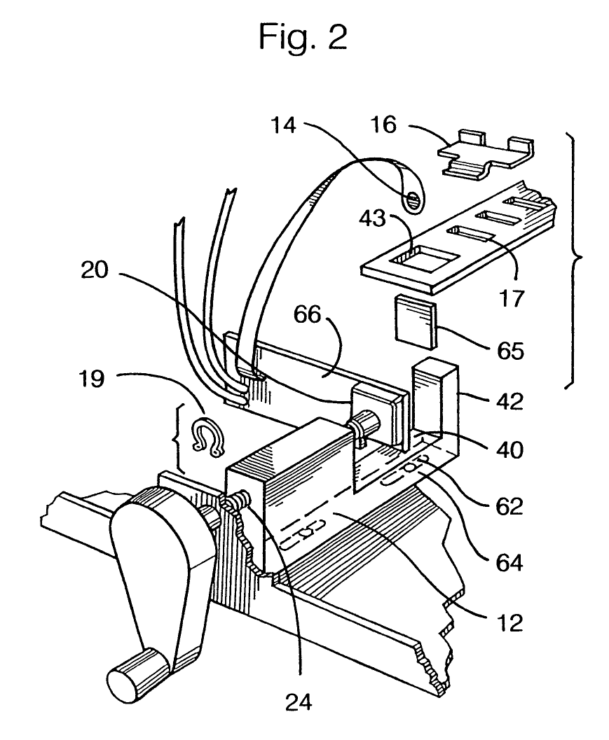

Various aspects of the invention are presented in FIGS. 1-2 which are not drawn to scale and in which like components are numbered alike. Referring now to FIGS. 1-2, according to an aspect of the invention, An educational device to measure the strength and deflection of a sample truss 13 comprises a mounting base 10 having opposing posts 11, an adjustable sliding force plate 15, a load clip 16, a pulling means 30, a force measuring means 14, and a deflection measuring means 20. The truss has a longitudinal side 32 and an opposing side with a load point 34, and a first end 36 and an opposing second end 38. The truss 13 is laid on the sliding force plate 15 such that the longitudinal side 32 is against the opposing posts 11, wherein one post is at the first end 36 and one post is at the second end 38. The load clip 16 is mounted on the sliding force plate 15, and centered relative to the opposing posts 11, such that when the truss 13 is placed on the sliding force plate 15, the load clip 16 is against the truss load point 34. The pulling means 30 functions to pull the load clip 16 against the truss load point 34, which in turn pulls the truss longitudinal side 32 against the opposing posts 11, causing a load on the truss 13. A force measuring means 14 is then used for measuring the load caused by the pulling means 30, and a deflection measuring means 20 is used for measuring the deflection of the truss 13 caused by the pulling means 30.

According to an aspect of the invention, the force plate 15 further comprises adjustment slots 17 for attachment of the load clip 16 at various locations to allow for different sized trusses.

According to an aspect of the invention, the force measuring means 14 is a strain gage. The strain gage provides an analog signal, which is sent to a computing and display device through a computer interface 50. There the signal may be converted and recorded. In a preferred embodiment of the invention, the strain gage analog signal is routed through a PC card 66 which converts the signal to digital before it reaches the computer interface 50.

According to a further aspect of the invention, the pulling means 30 is a crank 18 and screw 24 combination, wherein turning the crank 18 turns the screw 24 which in turn pulls the adjustable sliding force plate 15. A retainer ring 19 is used to retain the screw in the proper position, such that all the motion caused by turning the crank results in motion in the desired direction.

According to a further aspect of the invention, the strain gage 14 is located between the force plate 15 and the pulling means 30, such that the force measured by the strain gage 14 corresponds to the load on the truss 13.

According to an aspect of the invention, the pulling means 30 operates by pulling a slide block 12. The slide block 12 is slidably mounted to the base 10 by screws 64 in slots 62. The slide block 12 has a U-shaped cut out 40. This U-shaped cut out 40 leaves a leg 42 at the end of the slide block 12. Force plate 15 has a pulling slot 43, sized to accommodate the slide block leg 42. Thus the slide block leg 42 is inserted into the force plate pulling slot 43. Thus the pulling mechanism 30 pulls the slide block 12, which by leg 42 in pulling slot 43 pulls the force plate 15.

In a preferred embodiment of the invention, there is also a pressure plate 65 which is sized to fit in the pulling slot 43. The measuring means 14 sits between the slide block leg 42 and the pressure plate 65, such that when the slide block leg 42 pulls the force plate 15, it also presses the measuring means 14 against the pressure plate 65.

In a preferred embodiment of the invention, the deflection measuring means 20 is an encoder which records the turns made by the crank 18 and screw 24, and converts this to distance using the pitch of the screw thread. This encoder may also send a digital signal to a computer through a computer interface 50, thus allowing for conversion and recording of the signal.

In a further preferred embodiment, there is a cover plate 21, for covering the truss 13 while it is being deflected. This is useful to help restrain the truss 13 in the test position, and keep it from pulling upward as force is applied. It is also a useful safety cover in case the breaking truss 13 sends flying fragments.

According to another aspect of the invention, there is a support plate 26, wherein the support plate 26 supports the force plate 15 and the truss 13.

I claim:

1. An educational device to measure the strength and deflection of a sample truss comprising:
a mounting base having opposing posts;
an adjustable sliding force plate, wherein the truss has a longitudinal side and an opposing side with a load point, and a first end and an opposing second end, and wherein the truss is laid on said sliding force plate such that said longitudinal side is against said opposing posts, wherein one post is at said first end and one post is at said second end;
a load clip mounted on said sliding force plate, and centered relative to the opposing posts, such that when the truss is placed on said sliding force plate, said load clip is against the truss load point;
a pulling means, wherein said pulling means functions to pull said load clip against said truss load point, which in turn pulls said truss first longitudinal side against said opposing posts, causing a load on the truss;
a force measuring means for measuring the load caused by said pulling means; and,
a deflection measuring means for measuring the deflection of the truss caused by said pulling means.

2. The educational device to measure the strength and deflection of a truss of claim 1 wherein said force measuring means is a strain gage.

3. The educational device to measure the strength and deflection of a truss of claim 1 wherein said pulling means is a crank and screw combination, wherein turning the crank turns the screw which in turn pulls the adjustable sliding force plate.

4. The educational device to measure the strength and deflection of a truss of claim 3 wherein said deflection measuring means is an encoder which records the turns made by the crank and screw, and converts this to distance using the pitch of the screw thread.

5. The educational device to measure the strength and deflection of a truss of claim 1 further comprising a cover plate, for covering said truss while it is being deflected.

6. The educational device to measure the strength and deflection of a truss of claim 1 further comprising a support plate, wherein said support plate supports said force plate and the truss.

7. The educational device to measure the strength and deflection of a truss of claim 2 wherein said strain gage is located between said force plate and said pulling means, such that the force measured by said strain gage corresponds to said load on the truss.

8. The educational device to measure the strength and deflection of a truss of claim 1 wherein said force plate further comprises adjustment slots for attachment of said load clip at various locations, to allow for different sized trusses.

9. The educational device to measure the strength and deflection of a truss of claim 1 wherein the pulling means operates by pulling a slide block; wherein said slide block is slidably mounted to said mounting base by screws in slots, wherein said slide block further has a U-shaped cut out, wherein said U-shaped cut out leaves a leg at an end of said slide block; further wherein said force plate has a pulling slot which is sized to accommodate said slide block leg; wherein said slide block leg is inserted into said force plate pulling slot.

10. The educational device to measure the strength and deflection of a truss of claim 9 further comprising a pressure plate which is sized to fit in said pulling slot, wherein said measuring means sits between said slide block leg and said pressure plate, such that when said slide block leg pulls said force plate, said measuring means is pressed between said pressure plate and said slide block leg.
